(19) United States
(12) Patent Application Publication
(10) Pub. No.: US 2014/0318788 A1
(43) Pub. Date: Oct. 30, 2014

(54) VISCOSIFIED BREAKER FLUID COMPOSITIONS FOR EXTENDED DELAY IN FILTERCAKE REMOVAL AT HIGH TEMPERATURE

(71) Applicant: HALLIBURTON ENERGY SERVICES, INC., Houston, TX (US)

(72) Inventors: Amit Chandrakant Agrawal, Pune (IN); Amar Deep Pathak, Varanasi (IN); Achala Vasudev Danait, Pune (IN)

(73) Assignee: Halliburton Energy Services, Inc., Houston, TX (US)

(21) Appl. No.: 13/871,499

(22) Filed: Apr. 26, 2013

(51) Int. Cl. C09K 8/62; C09K 8/02; C09K 8/52; C09K 8/58

(52) U.S. Cl. CPC C09K 8/62; C09K 8/58; C09K 8/02; C09K 8/52
USPC 166/300; 507/100; 507/200

(57) ABSTRACT

The present invention relates to a method of treating a subterranean formation. The present invention also relates to a method of delivering an acid to a subterranean formation. The methods include obtaining or providing a composition that includes filter cake breaker, viscosifier, corrosion inhibitor, and pH buffering agent. The methods also include contacting the composition with a subterranean material downhole. The present invention also relates to a composition for the treatment of a subterranean formation. The composition includes: filter cake breaker, viscosifier, corrosion inhibitor, pH buffering agent, and at least one of drilling fluid, stimulation fluid, fracturing fluid, spotting fluid, clean-up fluid, production fluid, completion fluid, remedial treatment fluid, abandonment fluid, pill, acidizing fluid, cementing fluid, and packer fluid.

### BACKGROUND OF THE INVENTION

During drilling operations, drill-in fluids consisting of fluid loss control additives are pumped into the formation. The fluid loss control additives primarily function by forming a filtercake on the face of the wellbore, thereby reducing the fluid loss into the formation. After completion of the drilling operations, and when the well is required to be put on production, it is important to remove the filtercake completely, thereby maximizing production. Inefficient removal of filtercake can lead to decrease in production rates.

Breaker fluids are usually employed to remove the filtercake. The break times are required to be higher than the time needed for completion work, in order to reduce the premature fluid loss of the breaker into the formation. At temperatures above 220° F., it is challenging to retard the breaker action. Commonly used delayed breaker systems are esters of organic acids or organic compounds which can release acids slowly at bottom hole temperatures. This acid release rate is dependent on temperature as well as various other factors. As temperatures increase, the rate of acid release also increases. Hence, at higher temperatures, it is difficult to optimize a breaker recipe to achieve the desired delay to suit job requirements.

### SUMMARY OF THE INVENTION

In various embodiments, the present invention provides a method of treating a subterranean formation. The method includes obtaining or providing a composition that includes a filter cake breaker, viscosifier, corrosion inhibitor, and pH buffering agent. The method also includes contacting the composition with a subterranean material downhole.

In various embodiments, the present invention provides a method for delivering acid to a subterranean formation. The method includes obtaining or providing a composition that includes a filter cake breaker, viscosifier, corrosion inhibitor, and pH buffering agent. The method also includes contacting the composition with a subterranean material downhole.

In various embodiments, the present invention provides a method for extending or delaying a break time in a subterranean formation. The method includes obtaining or providing a composition that includes a filter cake breaker, viscosifier, corrosion inhibitor, and pH buffering agent. The method also includes contacting the composition with a subterranean material downhole.

In various embodiments, the present invention provides a composition for the treatment of a subterranean formation. The composition includes a filter cake breaker, viscosifier, corrosion inhibitor, and pH buffering agent.

In various embodiments, the present invention provides a composition for the treatment of a subterranean formation. The composition includes a filter cake breaker, viscosifier, corrosion inhibitor, pH buffering agent, and at least one of a drilling fluid, stimulation fluid, fracturing fluid, spotting fluid, clean-up fluid, production fluid, completion fluid, remedial treatment fluid, abandonment fluid, pill, acidizing fluid, cementing fluid, and packer fluid.

In various embodiments, any one of the methods for treating the subterranean formation can be carried out wherein the treating the subterranean formation occurs over an extended period of time (e.g., at least about 2.5 hours after contacting the composition with the subterranean material downhole).

In various embodiments, any one of the methods for treating the subterranean formation can be carried out wherein treating the subterranean formation occurs with a subterranean formation having an elevated temperature (e.g., at least about 220° F.).

In various embodiments, the viscosified breaker system will act on the filter cake and will not form its own filter cake on the exposed formation face. In such embodiments, no additional damage to the formation is expected, due to addition of viscosifier in the breaker recipe.

In various embodiments, the total clean-up time with and without the viscosifier is almost the same (in this case, 30 hrs). This indicates that no additional rig time is required with the new viscosified system for achieving complete clean-up.

### BRIEF DESCRIPTION OF THE FIGURES

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 illustrates a schematic diagram of delayed breaker action at high temperature.

FIG. 2 illustrates a picture of a disc with filter cake before treatment.

FIG. 3 illustrates a picture of a disc with cleaned filter cake after treatment.

FIG. 4 illustrates a graph of rate of acid release of filter cake breaker.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of manufacturing described herein, the steps can be carried out in any order without departing from the principles of the invention, except when a temporal or operational sequence is explicitly recited. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more.

The term “downhole” as used herein refers to under the surface of the earth, such as a location within or fluidly connected to a wellbore.

As used herein, the term “drilling fluid” refers to fluids, slurries, or muds used in drilling operations downhole, such as the formation of the wellbore.

As used herein, the term “stimulation fluid” refers to fluids or slurries used downhole during stimulation activities of the well that can increase the production of a well, including perforation activities. In some examples, a stimulation fluid can include a fracturing fluid, or an acidizing fluid.

As used herein, the term “clean-up fluid” refers to fluids or slurries used downhole during clean-up activities of the well, such as any treatment to remove material obstructing the flow of desired material from the subterranean formation. In one example, a clean-up fluid can be an acidification treatment to remove material formed by one or more perforation treatments. In another example, a clean-up fluid can be used to remove a filter cake.

As used herein, the term “fracturing fluid” refers to fluids or slurries used downhole during fracturing operations.

As used herein, the term “spotting fluid” refers to fluids or slurries used downhole during spotting operations, and can be any fluid designed for localized treatment of a downhole region. In one example, a spotting fluid can include a lost circulation material for treatment of a specific section of the wellbore, such as to seal off fractures in the wellbore and prevent sag. In another example, a spotting fluid can include a water control material. In some examples, a spotting fluid can be designed to free a stuck piece of drilling or extraction equipment, can reduce torque and drag with drilling lubricants, prevent differential sticking, promote wellbore stability, and can help to control mud weight.

As used herein, the term “production fluid” refers to fluids or slurries used downhole during the production phase of a well. Production fluids can include downhole treatments designed to maintain or increase the production rate of a well, such as perforation treatments, clean-up treatments, or remedial treatments.

As used herein, the term “completion fluid” refers to fluids or slurries used downhole during the completion phase of a well, including cementing compositions.

As used herein, the term “remedial treatment fluid” refers to fluids or slurries used downhole for remedial treatment of a well. Remedial treatments can include treatments designed to increase or maintain the production rate of a well, such as stimulation or clean-up treatments.

As used herein, the term “abandonment fluid” refers to fluids or slurries used downhole during or preceding the abandonment phase of a well.

As used herein, the term “acidizing fluid” refers to fluids or slurries used downhole during acidizing treatments downhole. In one example, an acidizing fluid is used in a clean-up operation to remove material obstructing the flow of desired material, such as material formed during a perforation operation. In some examples, an acidizing fluid can be used for damage removal.

As used herein, the term “cementing fluid” refers to fluids or slurries used during cementing operations of a well. For example, a cementing fluid can include an aqueous mixture including at least one of cement and cement kiln dust. In another example, a cementing fluid can include a curable resinous material such as a polymer that is in an at least partially uncured state.

As used herein, the term “water control material” refers to a solid or liquid material that interacts with aqueous material downhole, such that hydrophobic material can more easily travel to the surface and such that hydrophilic material (including water) can less easily travel to the surface. A water control material can be used to treat a well to cause the proportion of water produced to decrease and to cause the proportion of hydrocarbons produced to increase, such as by selectively binding together material between water-producing subterranean formations and the wellbore while still allowing hydrocarbon-producing formations to maintain output.

As used herein, the term “packing fluid” refers to fluids or slurries that can be placed in the annular region of a well between tubing and outer casing above a packer. In various examples, the packer fluid can provide hydrostatic pressure in order to lower differential pressure across the sealing element, lower differential pressure on the wellbore and casing to prevent collapse, and protect metals and elastomers from corrosion.

As used herein, the term “fluid” refers to liquids and gels, unless otherwise indicated.

As used herein, the term “subterranean material” or “subterranean formation” refers to any material under the surface of the earth, including under the surface of the bottom of the ocean. For example, a subterranean material can be any section of a wellbore and any section of an underground formation in fluid contact with the wellbore, including any materials placed into the wellbore such as cement, drill shafts, liners, tubing, or screens. In some examples, a subterranean material can be any below-ground area that can produce liquid or gaseous petroleum materials, water, or any section below-ground in fluid contact therewith.

### Method of Treating a Subterranean Formation

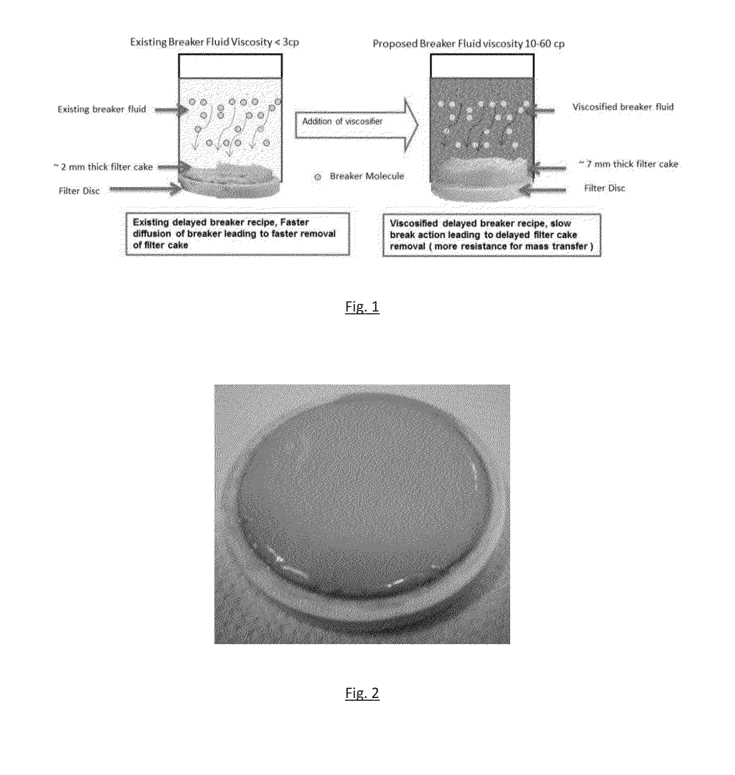

Without being bound to any particular theory, it is believed that desired delayed break time at higher temperature can be achieved by increasing the viscosity of breaker fluid. It is further believed that an increased viscosity of the breaker fluid will lead to a decrease in diffusion rate of breaker onto the filter cake. It is also believed that this will in turn lead to a slower rate of filter cake removal and hence achieve the desired delay at high temperatures. See FIG. 1.

In various embodiments, the present invention provides a method of treating a subterranean formation. The method can include obtaining, or providing, a composition that includes a filter cake breaker, a viscosifier, a corrosion inhibitor, and a pH buffering agent. The method can also include contacting the composition with a subterranean material downhole.

In various embodiments, the method of treating a subterranean formation can include at least one of: (1) degrading at least one of drill-in-fluid (DIF) filter cake deposits and drill-in-fluid (DIF) filter cake residue, located downhole; (2) removing at least one of drill-in-fluid (DIF) filter cake deposits and drill-in-fluid (DIF) filter cake residue, located downhole; (3) increasing a downhole flow rate; (4) breaking polymer gels located downhole; (5) breaking polymer gels located downhole, over an extended period of time; (6) delivering acid to the subterranean formation; (7) providing an extended release of acid to the subterranean formation; (8) providing a delayed release of acid to the subterranean formation; (9) extending a break time in a subterranean formation; (10) delaying a break time in a subterranean formation; (11) reducing premature fluid loss into a formation; (12) retarding the breaker action.

The subterranean formation can have any suitable location. In various embodiments, the subterranean formation can have a location in a deep water environment.

The composition that contacts the subterranean material can be formed in any suitable location and at any suitable time. In various embodiments, the composition can be formed above the surface, or at or near the downhole location. In some embodiments, the composition can be formed downhole. For example, at least one of the filter cake breaker, viscosifier, corrosion inhibitor, and pH buffering agent can be placed downhole (e.g., pumped, injected) to join a downhole fluid mixture that is present downhole to form the composition that contacts the subterranean material. In another embodiment, the obtaining or providing of the composition can be performed above the surface. For example, a suitable downhole fluid can be combined with at least one of the filter cake breaker, viscosifier, corrosion inhibitor, and pH buffering agent above the surface to form the composition that can contact the subterranean material downhole.

The treatment of the subterranean formation can occur at any suitable time (or over any suitable period of time). In various embodiments, the treatment of the subterranean formation can occur at least about 2, 2.5, 3, 3.5, 4, 4.5, 5, 5.5, 6, 6.5, 7, 7.5, 8, 8.5, 9, 9.5 or 10 hours, after contacting the composition with the subterranean material downhole. In additional various embodiments, the treatment of the subterranean formation can occur up to about 4, 2, 3, 2, 1, or 0.5 days after contacting the composition with the subterranean material downhole. In additional various embodiments, the treatment of the subterranean formation can occur up to about 96, 72, 48, 24, 18, 16, 14, 13, 12, 11, 10, 9, 8, 7 or 6 hours after contacting the composition with the subterranean material downhole. In additional various embodiments, the treatment of the subterranean formation can occur between about 2.5 hours and 4 days, after contacting the composition with the subterranean material downhole. In additional various embodiments, the treatment of the subterranean formation can occur between about 2-96, 2-72, 2-48, 2-24, 2-18, 2-26, 2.5-15, 2.5-10, 3-10, 3.5-10, 3.5-9.5, 3.5-9, 4-9, 4.5-9, 4.5-8.5, 5-8.5 and 5-8 hours, after contacting the composition with the subterranean material downhole.

The conditions during the contacting of the composition with the subterranean material downhole can be any suitable conditions. In some embodiments, the conditions can be non-extreme conditions. In other embodiments, the conditions can be extreme conditions. In various embodiments, extreme conditions can include conditions typically considered at least one of high, ultra, or extreme. In some embodiments, during the contacting of the composition with the subterranean material downhole, the conditions include at least one of high temperature conditions, high salinity conditions, high pressure conditions, and high pH conditions, and lower pH conditions.

During the contacting of the composition with the subterranean material, the downhole temperature can be any suitable temperature. In various embodiments, during the contacting of the composition with the subterranean material downhole, the conditions can include a temperature of about 50 to about 600° F., or about 150 to about 450° F., or less than about 50° F. In additional various embodiments, during the contacting of the composition with the subterranean material downhole, the conditions can include a temperature of at least about 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 375, 400, 450, 500, or 600° F. In specific embodiments, during the contacting of the composition with the subterranean material downhole, the conditions can include a temperature of up to about 325, 320, 315, 310, 305, 300, 295, 290, 285, 280, 275, 270, 265, 260, 255, 250 or 245° F. In additional specific embodiments, during the contacting of the composition with the subterranean material downhole, the conditions can include a temperature of at least about 200, 205, 210, 215, 220, 225, 230, 235, 240, 245, 250, 255, 260, 265, or 270° F. In additional specific embodiments, during the contacting of the composition with the subterranean material downhole, the conditions can include a temperature of about 200-300° F., 205-295° F., 210-290° F., 215-285° F., or 220-285° F.

During the contacting of the composition with the subterranean material, the downhole salinity can be any suitable salinity. In some embodiments, during the contacting of the composition with the subterranean material downhole, the conditions can include a salt concentration of about 0.001 ppg to about 16 ppg. In various embodiments, during the contacting of the composition with the subterranean material downhole, the conditions can include a salt concentration of at least about 0.001, 0.005, 0.01, 0.05, 0.1, 0.5, 1.0, 1.5, 2, 4, 6, 8, 10, 12, or 14 ppg. In additional various embodiments, during the contacting of the composition with the subterranean material downhole, the conditions can include a salt concentration of up to about 16, 15.5, 15, 14.5, 14, 13.5, 13, 12.5, 12, 11.5, 11, 10.5, 10, 9, 8, 7, 6, 5, 4, 3, 2, 1, 0.5, 0.1, 0.05, 0.01, 0.005, or 0.001 pounds per gallon (ppg).

In various embodiments, the salt can include at least one of NaCl, KCl, KBr, NaBr, CaCl₂, CaBr₂, ZnBr₂, and ZnCl₂. In various embodiments, the salt can include a mixture of two or more of NaCl, KCl, KBr, NaBr, CaCl₂, CaBr₂, ZnBr₂, and ZnCl₂ (e.g., KCl+KBr, NaCl+NaBr, KCl+NaCl, NaCl+CaCl₂, CaCl₂+CaBr₂, CaCl₂+ZnCl₂, etc.).

During the contacting of the composition with the subterranean material, the downhole concentration of Na⁺ ions can be any suitable concentration of Na⁺ ions, such as about 5 ppmw to about 200,000 parts per million weight (ppmw), about 100 ppmw to about 7,000 ppmw, or about 250 ppmw to about 5,000 ppmw. In various embodiments, the downhole concentration of Na⁺ ions can be any suitable concentration of Na⁺ ions, such as at least about 5, 10, 25, 50, 100, 500, 1000, 5,000, 10,000, 15,000, 20,000, 50,000, 75,000, 100, 000, 150,000, or 200,000 ppmw.

During the contacting of the composition with the subterranean material, the downhole concentration of Cl⁻ ions can be any suitable concentration of Cl⁻ ions, such as about 10 ppmw to about 400,000 ppmw, about 200 ppmw to about 14,000 ppmw, or about 500 ppmw to about 10,000 ppmw. In various embodiments, the downhole concentration of Cl⁻ ions can be any suitable concentration of Cl⁻ ions, such as at least about 10, 20, 50, 100, 200, 500, 1,000, 2,500, 5,000, 7,500, 10,000, 12,500, or 14,000 ppmw.

During the contacting of the composition with the subterranean material, the downhole concentration of K⁺ ions can be any suitable concentration of K⁺ ions, such as about 1 ppmw to about 70,000 ppmw, about 40 ppmw to about 2,500 ppmw, or about 80 ppmw to about 1,500 ppmw. In various embodiments, the downhole concentration of K⁺ ions can be any suitable concentration of K⁺ ions, such as at least about 1, 10, 20, 50, 100, 200, 500, 1,000, 2,500, 5,000, 10,000, 15,000, 20,000, 25,000, 50,000, or 70,000 ppmw.

During the contacting of the composition with the subterranean material, the downhole concentration of Ca²⁺ ions can be any suitable concentration of Ca²⁺ ions, such as about 1 to about 70,000, or about 40 to about 2,500, or about 60 to about 1,500 ppmw. In various embodiments, the downhole concentration of Ca²⁺ ions can be any suitable concentration of Ca²⁺ ions, such as at least about 1, 10, 20, 50, 100, 200, 500, 1,000, 2,500, 5,000, 10,000, 15,000, 20,000, 25,000, 50,000, or 70,000 ppmw.

During the contacting of the composition with the subterranean material, the downhole concentration of Br ions can be any suitable concentration of Br⁻ ions, such as about 0.1 ppmw to about 12,000 ppmw, or about 5 ppmw to about 450 ppmw, or about 10 ppmw to about 350 ppmw. In various embodiments, the downhole concentration of Br ions can be any suitable concentration of Br⁻ ions, such as at least about 0.1, 0.5, 1, 10, 20, 50, 100, 200, 500, 1,000, 2,500, 5,000, 10,000, 15,000, 20,000, or 25,000 ppmw.

During the contacting of the composition with the subterranean material, the downhole pressure can be any suitable pressure. In some embodiments, during the contacting of the composition with the subterranean material downhole, the conditions can include a pressure of about 100 psi to about 250,000 psi, about 5,000 psi to about 200,000 psi, or about 10,000 psi to about 100,000 psi.

In various embodiments, during the contacting of the composition with the subterranean material downhole, the conditions can include a pressure of at least about 10 psi, 50 psi, 100 psi, 250 psi, 500 psi, 750 psi, 1,000 psi, 5,000 psi, 7,500 psi, 10,000 psi, 12,500 psi, 15,000 psi, 17,500 psi, 20,000 psi, 22,500 psi, 25,000 psi, 27,500 psi, 30,000 psi, 32,500 psi, 35,000 psi, 37,500 psi, 40,000 psi, 42,500 psi, 45,000 psi, 47,500 psi, 50,000 psi, 60,000 psi, 75,000 psi, 100,000 psi, 125,000 psi, 150,000 psi, 175,000 psi, or 200,000 psi.

In various embodiments, during the contacting of the composition with the subterranean material downhole, the conditions can include a pressure of up to about 200,000 psi, 175,000 psi, 150,000 psi, 125,000 psi, 100,000 psi, 75,000 psi, 60,000 psi, 50,000 psi, 47,500 psi, 45,000 psi, 42,500 psi, 40,000 psi, 37,500 psi, 35,000 psi, 32,500 psi, 30,000 psi, 27,500 psi, 25,000 psi, 22,500 psi, 20,000 psi, 17,500 psi, 15,000 psi, 12,500 psi, 10,000 psi, 7,500 psi, 5,000 psi, 1,000 psi, 750 psi, 500 psi, 250 psi, 100 psi, 50 psi, or 10 psi.

During the contacting of the composition with the subterranean material, the downhole pH can be any suitable pH. In some embodiments, during the contacting of the composition with the subterranean material downhole, the conditions can include a pH of about 0 to about 14, about 1 to about 13, or about 2 to about 12. In some embodiments, during the contacting of the composition with the subterranean material downhole, the conditions can include a pH of at least about 0.5, 1, 2, 3, 4, 5, 6, 7, 8, 9, 10, 11, 12, 13, or 13.5. In some embodiments, during the contacting of the composition with the subterranean material downhole, the conditions can include a pH of less than about 14, 13, 12, 11, 10, 9, 8, 7, 6, 5, 4, 3, 2, or 1.

The viscosity of the composition prior to the contacting of the composition with the subterranean formation can be any suitable viscosity. In some embodiments, the composition prior to contacting with the subterranean material (e.g. before placing downhole, or before the composition reaches the subterranean material downhole) can be free-flowing, while in other embodiments the composition can be a thick liquid. In various embodiments, the viscosity of the composition prior to contacting with the subterranean material can be about 0.01 cP-50,000 cP, 0.1 cP-10,000 cP, or about 0.2 cP-1,000 cP, measured at standard temperature and pressure. In various embodiments, the viscosity of the composition prior to contacting with the subterranean material can be at least about 0.01 cP, 0.1 cP, 1 cP, 5 cP, 10 cP, 15 cP, 20 cP, 50 cP, 100 cP, 200 cP, 500 cP, 1000 cP, 5000 cP, 10,000 cP, or 50,000 cP, measured at standard temperature and pressure.

The increase in viscosity (due in part to the viscosifier) can be any suitable increase in viscosity. In some examples, the increase in viscosity is a thickening of the composition. In some embodiments, the increase in viscosity can be so great that it can be characterized as a gelling of the composition. As used herein, “gel” refers to a solid, jelly-like material that can have properties ranging from soft and weak to hard and tough. Gels can be substantially dilute crosslinked systems, which can exhibit little or no flow. Gels can behave like solids or thick liquids but include predominantly liquid by weight. In some embodiments, the resulting viscosity after contacting with the subterranean material and after generation of a compound that modifies the viscosity of the composition can be an intermediate viscosity, wherein the viscosity of the composition can be further increased at a later time. In some embodiments, the resulting viscosity after contacting with the subterranean material and after generation of a compound that modifies the viscosity of the composition before or after contacting with the subterranean material, can be a final viscosity, with little or no further viscosity increase occurring later in the composition. The resulting viscosity of the composition can be 0.01 cP to 1,000,000,000 cP or more (e.g., the composition can be a gel having essentially infinite viscosity), 1 cP to about 100,000,000 cP, or about 10 cP to about 1,000,000 cP. In various embodiments, the resulting viscosity of the composition can be at least about 0.1 cP, 1 cP, 5 cP, 10 cP, 15 cP, 20 cP, 50 cP, 100 cP, 200 cP, 500 cP, 1000 cP, 5000 cP, 10,000 cP, 50,000 cP, 100,000 cP, 500,000 cP, 1,000,000 cP, 10,000,000 cP, 100,000,000 cP, 500,000,000 cP, or 1,000,000,000 cP.

In some embodiments, the increase in viscosity or gelation can be reversible. In other embodiments, the increase in viscosity or gelation can be irreversible. In some embodiments, the gel can be a thixotropic gel.

### Composition

In various embodiments, the invention provides for the use of a composition that includes a filter cake breaker, a viscosifier, a corrosion inhibitor, and pH buffering agent, for use in treating a subterranean formation. As described herein, the method can include contacting the composition with a subterranean material downhole.

Any suitable filter cake breaker can be employed. In various embodiments, the filter cake breaker comprises an acid generator. In additional various embodiments, the filter cake breaker is configured for the release of acid. In additional various embodiments, the filter cake breaker includes at least one of alkyl lactate filter cake breaker and alkyl formate ester filter cake breaker.

The filter cake breaker can be employed in any suitable amount. In various embodiments, the filter cake breaker is present in up to about 35 wt. %, 30 wt. %, 25 wt. %, 20 wt. %, 15 wt. %, or 10 wt. % of the composition. In additional various embodiments, the filter cake breaker is present in at least about 0.1 wt. %, 0.5 wt. %, 1 wt. %, 5 wt. %, 10 wt. %, 15 wt. %, or 20 wt. % of the composition. In additional various embodiments, the filter cake breaker is present in about 0.5-35 wt. %, 0.1-30 wt. %, 1-25 wt. %, 5-25 wt. %, or 5-20 wt. % of the composition.

Any suitable viscosifier can be employed. In various embodiments, the viscosifier includes a hydroxyethylcullose (HEC) polymer. In additional various embodiments, the viscosifier includes a hydroxyethylcullose (HEC) polymer dispersed in a water-soluble carrier. In additional various embodiments, the viscosifier includes solvent dispersed hydroxy ethyl cellulose viscosifier. In additional various embodiments, the viscosifier includes a derivatized hydroxyethylcullose (HEC) polymer that is crosslinkable. In additional various embodiments, the viscosifier includes derivatized hydroxylethyl cellulose (HEC) gelling agent.

The viscosifier can be employed in any suitable amount. In various embodiments, the viscosifier is present in at least about 0.01 wt. %, 0.05 wt. %, 0.1 wt. %, 0.2 wt. %, 0.3 wt. %, 0.4 wt. %, 0.5 wt. %, or 1.0% of the composition. In various embodiments, the viscosifier is present in up to about 10 wt. %, 5 wt. %, 4.5 wt. %, 4 wt. %, 3.5 wt. %, 3 wt. %, 2.5 wt. %, 2.25 wt. %, 2 wt. %, or 1.75 wt. % of the composition. In various embodiments, the viscosifier is present in about 0.01-10 wt. %, 0.05-5 wt. %, 0.1-4.5 wt. %, 0.2-4 wt. %, 0.3-4 wt. %, 0.4-3.5 wt. %, 0.4-3 wt. %, 0.4-2.5 wt. %, or 0.4-2.25 wt. % of the composition.

Depending upon the desired pH range, any suitable pH buffering agent, in any suitable amount, can be employed. In various embodiments, the pH buffering agent can include a near neutral pH buffering agent. In various embodiments, the pH buffering agent can include alkali bicarbonate breaker pH buffering agent. The composition can have any suitable pH. In various embodiments, the pH of the composition is at least about 2, 3, 4, 5, or 6. In additional various embodiments, the pH of the composition is up to about 10, 9, 8, or 7. In various embodiments, the pH of the composition is about 4-9, 4.5-9, 4-8.5, 4.5-8.5, 5-8, 5.5-8, 5-7.5, or 5.5-7.5.

### Downhole Mixture or Composition

In various embodiments, at least one of before, during, or after the contacting of the subterranean material and the composition including at least one of a filter cake breaker, viscosifier, corrosion inhibitor, and pH buffering agent, the composition including at least one of a filter cake breaker, viscosifier, corrosion inhibitor, and pH buffering agent, that is contacted with a subterranean material can be any suitable downhole composition, such as any suitable composition used downhole for the drilling, completion, and production phases of a well. In various examples, the composition can be formed above the surface, in the borehole above a location wherein the properties of the composition are desired to be modified, or at or near the downhole location wherein the composition including at least one of a filter cake breaker, viscosifier, corrosion inhibitor, and pH buffering agent is contacted with the subterranean material. In some examples, at least one of a filter cake breaker, viscosifier, corrosion inhibitor, and pH buffering agent can include a suitable carrier material such as water or another solvent, and can be injected downhole to join a downhole fluid that is present downhole to form the composition that contacts the subterranean material. In another embodiment, a downhole fluid can be combined with at least one of a filter cake breaker, viscosifier, corrosion inhibitor, and pH buffering agent above the surface to form the composition that can contact the subterranean material downhole.

For example, in some embodiments, the filter cake breaker, viscosifier, corrosion inhibitor, and pH buffering agent can be combined with any suitable downhole fluid, such as a drilling fluid, fluid loss control additive, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof, to form the composition for contacting with the subterranean material. A mixture that is contacted with the subterranean material can include any suitable weight percent of the filter cake breaker, viscosifier, corrosion inhibitor, pH buffering agent, or combination thereof, such as about 1×10⁻⁸ wt. % to 99.999.99 wt. %, 1×10⁻⁴ wt. % to 99.9 wt. %, 0.1 wt. % to 99.9 wt. %, or 20-90 wt. %. In various embodiments, a mixture that is contacted with the subterranean material can include any suitable weight percent of the filter cake breaker, viscosifier, corrosion inhibitor, or combination thereof, such as at least about 1×10⁻⁸ wt. %, 1×10⁻⁶ wt. %, 1×10⁻⁴ wt. %, 1×10⁻³ wt. %, 0.01 wt. %, 0.1 wt. %, 1 wt. %, 2 wt. %, 3 wt. %, 4 wt. %, 5 wt. %, 10 wt. %, 15 wt. %, 20 wt. %, 30 wt. %, 40 wt. %, 50 wt. %, 60 wt. %, 70 wt. %, 80 wt. %, 85 wt. %, 90 wt. %, 91 wt. %, 92 wt. %, 93 wt. %, 94 wt. %, 95 wt. %, 96 wt. %, 97 wt. %, 98 wt. %, 99 wt. %, 99.9 wt. %, 99.99 wt. %, 99.999 wt. %, 99.999.9 wt. %, or 99.999.99 wt. % of the composition.

In some examples, the composition including at least one of a filter cake breaker, viscosifier, corrosion inhibitor, and pH buffering agent can be used to treat a subterranean formation at a desired time or in a desired place, such as before or after placing the drilling fluid or other fluid downhole, or before, during, or after contacting a subterranean material with the drilling fluid or other fluid. In some embodiments, the composition advantageously is employed while the drilling fluid or other fluid is being used.

A drilling fluid, also known as a drilling mud or simply “mud,” is a specially designed fluid that is circulated through a wellbore as the wellbore is being drilled to facilitate the drilling operation. The drilling fluid can be water-based or oil-based. The drilling fluid can carry cuttings up from beneath and around the bit, transport them up the annulus, and allow their separation. Also, a drilling fluid can cool and lubricate the drill head as well as reducing friction between the drill string and the sides of the hole. The drilling fluid aids in support of the drill pipe and drill head, and provides a hydrostatic head to maintain the integrity of the wellbore walls and prevent well blowouts. Specific drilling fluid systems can be selected to optimize a drilling operation in accordance with the characteristics of a particular geological formation. The drilling fluid can be formulated to prevent unwanted influxes of formation fluids from permeable rocks penetrated and also to form a thin, low permeability filter cake which temporarily seals pores, other openings, and formations penetrated by the bit. In water-based drilling fluids, solid particles are suspended in a water or brine solution containing other components. Oils or other non-aqueous liquids can be emulsified in the water or brine or at least partially solubilized (for less hydrophobic non-aqueous liquids), but water is the continuous phase.

A water-based drilling fluid in embodiments of the present invention can be any suitable water-based drilling fluid. In various embodiments, the drilling fluid can include at least one of water (fresh or brine), a salt (e.g., calcium chloride, sodium chloride, potassium chloride, magnesium chloride, calcium bromide, sodium bromide, potassium bromide, calcium nitrate, sodium formate, potassium formate, cesium formate), aqueous base (e.g., sodium hydroxide or potassium hydroxide), alcohol or polyol, cellulose, starches, alkalinity control agents, density control agents such as a density modifier (e.g. barium sulfate), surfactants (e.g. betaines, alkali metal alkylene acetates, sultaines, ether carboxylates), emulsifiers, dispersants, polymeric stabilizers, crosslinking agents, polyacrylamides, polymers or combinations of polymers, antioxidants, heat stabilizers, foam control agents, solvents, diluents, plasticizers, filler or inorganic particles (e.g. silica), pigments, dyes, precipitating agents (e.g., silicates or aluminum complexes), and rheology modifiers such as thickeners or viscosifiers (e.g. xanthan gum). Any ingredient listed in this paragraph can be either present or not present in the mixture. In various embodiments, the drilling fluid can be present in the mixture with the composition including at least one of a filter cake breaker, viscosifier, corrosion inhibitor, and pH buffering agent in any suitable amount, such as at least about 1 wt. %, 2 wt. %, 3 wt. %, 4 wt. %, 5 wt. %, 10 wt. %, 15 wt. %, 20 wt. %, 30 wt. %, 40 wt. %, 50 wt. %, 60 wt. %, 70 wt. %, 80 wt. %, 85 wt. %, 90 wt. %, 95 wt. %, 96 wt. %, 97 wt. %, 98 wt. %, 99 wt. %, 99.9 wt. %, 99.99 wt. %, 99.999 wt. %, or 99.9999 wt. % of the mixture. In various embodiments, the drilling fluid can be present in the mixture with the composition including at least one of a filter cake breaker, viscosifier, corrosion inhibitor, and pH buffering agent in any suitable amount, such as up to about 99.9999 wt. %, 99.999 wt. %, 99.99 wt. %, 99.9 wt. %, 99 wt. %, 98 wt. %, 97 wt. %, 96 wt. %, 95 wt. %, 90 wt. %, 85 wt. %, 80 wt. %, 70 wt. %, 60 wt. %, 50 wt. %, 40 wt. %, 30 wt. %, 20 wt. %, 15 wt. %, 10 wt. %, 5 wt. %, 4 wt. %, 3 wt. %, 2 wt. %, or 1 wt. % of the mixture.

An oil-based drilling fluid or mud in embodiments of the present invention can be any suitable oil-based drilling fluid. In various embodiments the drilling fluid can include at least one of an oil-based fluid (or synthetic fluid), saline, aqueous solution, emulsifiers, other agents of additives for suspension control, weight or density control, oil-wetting agents, fluid loss or filtration control agents, and rheology control agents. For example, see H. C. H. Darley and George R. Gray, Composition and Properties of Drilling and Completion Fluids 66-67, 561-562 (5^{th} ed. 1988). An oil-based or invert emulsion-based drilling fluid can include between about 50:50 to about 95:5 by volume of oil phase to water phase.

A pill is a relatively small quantity (e.g. less than about 500 bbl, or less than about 200 bbl) of drilling fluid used to accomplish a specific task that the regular drilling fluid cannot perform. For example, a pill can be a high-viscosity pill to, for example, help lift cuttings out of a vertical wellbore. In another example, a pill can be a freshwater pill to, for example, dissolve a salt formation. Another example is a pipe-freeing pill to, for example, destroy filter cake and relieve differential sticking forces. In another example, a pill is a lost circulation material pill to, for example, plug a thief zone. A pill can include any component described herein as a component of a drilling fluid.

A cement fluid can include an aqueous mixture of at least one of cement and cement kiln dust. The composition including at least one of a filter cake breaker, viscosifier, corrosion inhibitor, and pH buffering agent can form a useful combination with cement or cement kiln dust, for example by degrading at least one of drill-in-fluid (DIF) filter cake deposits and drill-in-fluid (DIF) filter cake residue, at a desired time or in a desired place.

The cement kiln dust can be any suitable cement kiln dust. Cement kiln dust can be formed during the manufacture of cement and can be partially calcined kiln feed which is removed from the gas stream and collected in a dust collector during manufacturing process. Cement kiln dust can be advantageously utilized in a cost-effective manner since kiln dust is often regarded as a low value waste product of the cement industry. Some embodiments of the cement fluid can include cement kiln dust but no cement, cement kiln dust and cement, or cement but no cement kiln dust. The cement can be any suitable cement. The cement can be a hydraulic cement. A variety of cements can be utilized in accordance with the present invention, for example, those including calcium, aluminum, silicon, oxygen, iron, or sulfur, which can set and harden by reaction with water. Suitable cements can include Portland cements, pozzolana cements, gypsum cements, high alumina content cements, slag cements, silica cements, and combinations thereof. In some embodiments, the Portland cements that are suitable for use in the present invention are classified as Classes A, C, H, and G cements according to the American Petroleum Institute, API Specification for Materials and Testing for Well Cements, API Specification 10, Fifth Ed., Jul. 1, 1990. A cement can be generally included in the cementing fluid in an amount sufficient to provide the desired compressive strength, density, or cost. In some embodiments, the hydraulic cement can be present in the cementing fluid in an amount in the range of from 0 wt. % to about 100 wt. %, 0-95 wt. %, 20-95 wt. %, or about 50-90 wt. %. A cement kiln dust can be present in an amount of at least about 0.01 wt. %, or about 5 wt. %-80 wt. %, or about 10 wt. % to about 50 wt. %.

Optionally, other additives can be added to a cement or kiln dust-containing composition of the present invention as deemed appropriate by one skilled in the art, with the benefit of this disclosure. Any optional ingredient listed in this paragraph can be either present or not present in the composition. For example, the composition can include fly ash, metakaolin, shale, zeolite, set retarding additive, surfactant, a gas, accelerators, weight reducing additives, heavy-weight additives, lost circulation materials, filtration control additives, dispersants, and combinations thereof. In some examples, additives can include crystalline silica compounds, amorphous silica, salts, fibers, hydratable clays, microspheres, pozzolan lime, thixotropic additives, combinations thereof, and the like.

In various embodiments, the composition that includes at least one of a filter cake breaker, viscosifier, corrosion inhibitor, and pH buffering agent can include any one or more additional ingredients. For example, the composition can further include water, brine (e.g., at least one of sodium chloride (NaCl), potassium chloride (KCl), potassium bromide (KBr), and sodium bromide (NaBr)), saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, density control agent, curing accelerator, curing retarder, pH modifier (e.g., at least one of an acid and base), pH buffering agent (e.g., a near neutral pH buffering agent), scale inhibitor, enzyme, resin, water control material, polymer, oxidizer, a marker, Portland cement, pozzolana cement, gypsum cement, high alumina content cement, slag cement, silica cement fly ash, metakaolin, shale, zeolite, a crystalline silica compound, amorphous silica, fibers, a hydratable clay, microspheres, pozzolan lime, or a combination thereof.

By adjusting various conditions such as temperature, pressure, salinity, and/or pH, and/or by adding or removing additional ingredients or adjusting the concentration thereof, the beginning and ending viscosity or other properties of the composition can be accurately and precisely controlled. In addition, variation of other parameters, such as those described in this paragraph, can cause variation in other properties of the composition aside from viscosity. In some embodiments, the properties that can be varied and in some embodiments controlled precisely can include density, surface tension of the composition (e.g. interfacial surface tension of an emulsion including the composition), size of the droplets or particles including the composition in an emulsion, stability of an emulsion including the composition, vapor pressure, propensity toward foaming or toward retention of foam, and ease of reversibility of increase in viscosity. By virtue of the temperature, pressure, salinity, or pH sensitive nature of properties of the composition such as viscosity, the variation of the properties can be advantageously caused to occur prior to the desired use of the composition, or at the location where the particular properties are desired. The variation of the properties can be advantageously caused to occur in a portion of the composition near or at the site where the particular properties are desired, while allowing the properties of the remainder of the composition to remain the same.

The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those of ordinary skill in the art, and that such modifications and variations are considered to be within the scope of this invention as defined by the appended claims.

### ENUMERATED EMBODIMENTS

Enumerated embodiments [1]-[53] provided below are for illustration purposes only and do not otherwise limit the scope of the invention, as defined by the claims. The enumerated embodiments [1]-[53] described below encompass all combinations and sub-combinations, whether or not expressly described as such.

[1.] A method of treating a subterranean formation, the method including:

obtaining or providing a composition including: filter cake breaker, viscosifier, corrosion inhibitor, and pH buffering agent; and contacting the composition with a subterranean material downhole.

[2.] The method of embodiment [1], further including combining the composition with an aqueous or oil-based fluid including a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof, to form a mixture, wherein the contacting of the subterranean material and the composition includes contacting the subterranean material and the mixture.
[3.] The method of any one of the above embodiments, wherein at least one of prior to, during, and after the contacting of the subterranean material and the composition, the composition is used downhole, at least one of alone and in combination with other materials, as a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof.
[4.] The method of any one of the above embodiments, wherein the composition further includes water, saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, density control agent, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement fly ash, metakaolin, shale, zeolite, a crystalline silica compound, amorphous silica, fibers, a hydratable clay, microspheres, pozzolan lime, or a combination thereof.
[5.] The method of any one of the above embodiments, wherein the treating the subterranean formation occurs at least about 2.5 hours after contacting the composition with the subterranean material downhole.
[6.] The method of any one of the above embodiments, wherein the treating the subterranean formation occurs up to about 4 days after contacting the composition with the subterranean material downhole.
[7.] The method of any one of the above embodiments, wherein the treating the subterranean formation occurs up to about 15 hours after contacting the composition with the subterranean material downhole.
[8.] The method of any one of the above embodiments, wherein the treating the subterranean formation occurs about 2.5 hours to about 4 days after contacting the composition with the subterranean material downhole.
[9.] The method of any one of the above embodiments, wherein the treating the subterranean formation occurs about 2.5 hours to about 15 hours after contacting the composition with the subterranean material downhole.
[10.] The method of any one of the above embodiments, wherein the treating the subterranean formation includes degrading at least one of drill-in-fluid (DIF) filter cake deposits and drill-in-fluid (DIF) filter cake residue, located downhole.
[11.] The method of any one of the above embodiments, wherein the treating the subterranean formation includes removing at least one of drill-in-fluid (DIF) filter cake deposits and drill-in-fluid (DIF) filter cake residue, located downhole.
[12.] The method of any one of the above embodiments, wherein the treating the subterranean formation includes increasing downhole flow rate.
[13.] The method of any one of the above embodiments, wherein the treating the subterranean formation includes breaking polymer gels located downhole.
[14.] The method of any one of the above embodiments, wherein the treating the subterranean formation includes breaking polymer gels located downhole, over an extended period of time.
[15.] The method of any one of the above embodiments, wherein the treating the subterranean formation includes delivering acid to the subterranean formation.
[16.] The method of any one of the above embodiments, wherein the treating the subterranean formation includes at least one of an extended release of acid to the subterranean formation and a delayed release of acid to the subterranean formation.
[17.] The method of any one of the above embodiments, wherein the treating the subterranean formation includes at least one of extending a break time in a subterranean formation and delaying a break time in a subterranean formation.
[18.] The method of any one of the above embodiments, wherein the treating the subterranean formation is carried out at a temperature up to about 285° F.
[19.] The method of any one of the above embodiments, wherein the treating the subterranean formation is carried out at a temperature at least about 220° F.
[20.] The method of any one of the above embodiments, wherein the treating the subterranean formation is carried out at a pressure of up to about 200,000 psi.
[21.] The method of any one of the above embodiments, which reduces premature fluid loss into a formation.
[22.] The method of any one of the above embodiments, wherein the subterranean formation is located in a deep water environment.
[23.] The method of any one of the above embodiments, wherein the filter cake breaker includes an acid generator, configured for the release of acid.
[24.] The method of any one of the above embodiments, wherein the filter cake breaker includes at least one of an alkyl lactate filter cake breaker and an alkyl formate ester filter cake breaker.
[25.] The method of any one of the above embodiments, wherein the filter cake breaker includes both an alkyl lactate filter cake breaker and an alkyl formate ester filter cake breaker.
[26.] The method of any one of the above embodiments, wherein the filter cake breaker is present in about 5 wt. % to about 25 wt. % of the composition.
[27.] The method of any one of the above embodiments, wherein the viscosifier includes a hydroxyethylcullose (HEC) polymer.
[28.] The method of any one of the above embodiments, wherein the viscosifier includes a hydroxyethylcullose (HEC) polymer dispersed in a water-soluble carrier.
[29.] The method of any one of the above embodiments, wherein the viscosifier includes solvent dispersed hydroxy ethyl cellulose viscosifier.
[30.] The method of any one of the above embodiments, wherein the viscosifier includes a derivatized hydroxyethylcullose (HEC) polymer that is crosslinkable.
[31.] The method of any one of the above embodiments, wherein the viscosifier includes derivatized hydroxylethyl cellulose (HEC) gelling agent.
[32.] The method of any one of the above embodiments, wherein the viscosifier is present in about 0.4% to about 2.25 wt. % of the composition.
[33.] The method of any one of the above embodiments, wherein the composition further includes water.
[34.] The method of any one of the above embodiments, wherein the composition further includes brine.
[35.] The method of any one of the above embodiments, wherein the composition further includes at least one of NaCl, KCl, KBr, NaBr, CaCl₂, CaBr₂, ZnBr₂, and ZnCl₂.
[36.] The method of any one of the above embodiments, wherein the composition further includes at least one of:

KCl+KBr,

NaCl+NaBr,

KCl+NaCl,

NaCl+CaCl₂,

CaCl₂+CaBr₂, and

CaCl₂+ZnCl₂.

[37.] The method of any one of the above embodiments, wherein the composition further includes a base.
[38.] The method of any one of the above embodiments, wherein the pH buffering agent includes a near neutral pH buffering agent.
[39.] The method of any one of the above embodiments, wherein pH buffering agent includes alkali bicarbonate breaker pH buffering agent.
[40.] The method of any one of the above embodiments, wherein the composition has a pH of about 5-8.
[41.] The method of any one of the above embodiments, wherein the composition has a viscosity of up to about 100 cP.
[42.] The method of any one of the above embodiments, wherein the composition is gelled.
[43.] The method of any one of the above embodiments, wherein the composition is gelled, such that the gelled composition is formed above ground.
[44.] The method of any one of the above embodiments, wherein the composition is gelled, such that the gelled composition is formed downhole.
[45.] A method for delivering acid to a subterranean formation, the method including:

obtaining or providing a composition including: filter cake breaker, viscosifier, corrosion inhibitor, and pH buffering agent; and

contacting the composition with a subterranean material downhole.

[46.] The method of embodiment [45], wherein the acid is released at least about 2.5 hours after the composition is contacted with the subterranean material downhole.
[47.] The method of embodiment [45], wherein the acid is released up to about 4 days after the composition is contacted with the subterranean material downhole.
[48.] The method of embodiment [45], wherein the acid is released up to about 15 hours after the composition is contacted with the subterranean material downhole.
[49.] The method of embodiment [45], wherein the acid is released about 2.5 hours to about 15 hours after the composition is contacted with the subterranean material downhole.
[50.] A method for extending or delaying a break time in a subterranean formation, the method including:

obtaining or providing a composition including: filter cake breaker, viscosifier, corrosion inhibitor, and pH buffering agent; and

contacting the composition with a subterranean material downhole.

[51.] A method for extending or delaying a break time in a subterranean formation, the method including:

obtaining or providing a composition described in any one of the above embodiments; and

contacting the composition with a subterranean material downhole.

[52.] A composition for the treatment of a subterranean formation including:

filter cake breaker,

viscosifier,

corrosion inhibitor,

pH buffering agent, and

at least one of drilling fluid, stimulation fluid, fracturing fluid, spotting fluid, clean-up fluid, production fluid, completion fluid, remedial treatment fluid, abandonment fluid, pill, acidizing fluid, cementing fluid, and packer fluid.

[53.] A composition for the treatment of a subterranean formation including:

a composition described in any one of the above embodiments, and

at least one of drilling fluid, stimulation fluid, fracturing fluid, spotting fluid, clean-up fluid, production fluid, completion fluid, remedial treatment fluid, abandonment fluid, pill, acidizing fluid, cementing fluid, and packer fluid.

### EXAMPLES

### Example 1

In a recent situation, a customer from Asia Pacific region was looking for a break time of 5-6 hours using an existing breaker system. Temperature of the targeted zone was 250° F. In laboratory testing, using a minimum concentration of alkyl lactate (12%), the maximum delay that was achieved at 250° F. was approximately 33 mins. This was possibly due to faster release of organic acid at such a high temperature. In order to achieve the delay of 5-6 hrs, lab tests were conducted by addition of a locally available viscosifier to the breaker fluid. Different concentrations of the viscosifier were added to evaluate the effect of viscosity on the break times.

Results of the Laboratory testing are as follows,

| | Intial Viscosity | | Breaker | | | Break | Complete | Final Viscosity |
|---|---|---|---|---|---|---|---|---|
| Test | of breaker fluid | | concentration | Initial | Final | Time in | Clean up | of breaker |
| No. | in cP | Viscosifier | % V/V | pH | pH | hrs | Time in hrs | fluid in cP |
| 1 | <3 | No | 12 | 6.5 | 3.2 | ~0.5 | 30 | <3 |
| 2 | 10 | Liqui Vis EP | 10 | 6.54 | 4.18 | 2.5 | 30 | 2 |
| 3 | 42 | Liqui Vis EP | 10 | 6.47 | 3.76 | 5.4 | 30 | 4 |
| 4 | 59 | Liqui Vis EP | 10 | 6.4 | 4.05 | 6.0 | 30 | 7 |

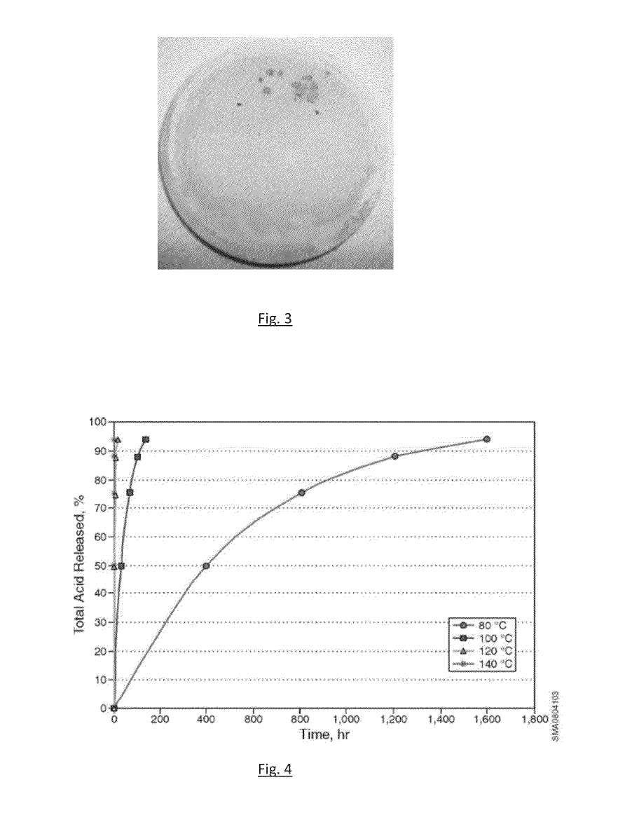

Representative picture of the disc before and after complete clean-up are illustrated in FIGS. 2 and 3, respectively.

### Example 2

An alkyl formate ester was used for delayed filter cake clean-up, for temperatures up to 194° F., and an alkyl lactate for temperatures up to 284° F. At higher temperatures (>220F), it became difficult to optimize a breaker recipe to achieve delay of a few hours break time. Work confirmed that it was challenging to get delayed break time by using alkyl lactate at 250° F., even with the minimum concentrations used. The graph at FIG. 4 illustrates the rate of acid release of alkyl lactate with time and temperature. The rate of acid release shown therein further confirms this challenge.

1. A method of treating a subterranean formation, the method comprising:
obtaining or providing a composition comprising: filter cake breaker, viscosifier, corrosion inhibitor, and pH buffering agent; and
contacting the composition with a subterranean material downhole.

2. The method of claim 1, further comprising combining the composition with an aqueous or oil-based fluid comprising a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof, to form a mixture, wherein the contacting of the subterranean material and the composition comprises contacting the subterranean material and the mixture.

3. The method of claim 1, wherein at least one of prior to, during, and after the contacting of the subterranean material and the composition, the composition is used downhole, at least one of alone and in combination with other materials, as a drilling fluid, stimulation fluid, fracturing fluid, spotting fluid, clean-up fluid, production fluid, completion fluid, remedial treatment fluid, abandonment fluid, pill, acidizing fluid, cementing fluid, packer fluid, or a combination thereof.

4. The method of claim 1, wherein the composition further comprises water, saline, aqueous base, oil, organic solvent, synthetic fluid oil phase, aqueous solution, alcohol or polyol, cellulose, starch, alkalinity control agent, density control agent, density modifier, emulsifier, dispersant, polymeric stabilizer, crosslinking agent, polyacrylamide, polymer or combination of polymers, antioxidant, heat stabilizer, foam control agent, solvent, diluent, plasticizer, filler or inorganic particle, pigment, dye, precipitating agent, rheology modifier, oil-wetting agent, set retarding additive, surfactant, gas, weight reducing additive, heavy-weight additive, lost circulation material, filtration control additive, dispersant, salt, fiber, thixotropic additive, breaker, crosslinker, gas, rheology modifier, density control agent, curing accelerator, curing retarder, pH modifier, chelating agent, scale inhibitor, enzyme, resin, water control material, polymer, oxidizer, a marker, Portland cement, pozzolana cement, gypsum cement, high alumina content cement, slag cement, silica cement fly ash, metakaolin, shale, zeolite, a crystalline silica compound, amorphous silica, fibers, a hydratable clay, microspheres, pozzolan lime, or a combination thereof.

5. The method of claim 1, wherein the treating the subterranean formation occurs at least about 2.5 hours after contacting the composition with the subterranean material downhole.

6. The method of claim 1, wherein the treating the subterranean formation occurs up to about 4 days after contacting the composition with the subterranean material downhole.

7. The method of claim 1, wherein the treating the subterranean formation occurs up to about 15 hours after contacting the composition with the subterranean material downhole.

8. The method of claim 1, wherein the treating the subterranean formation occurs about 2.5 hours to about 4 days after contacting the composition with the subterranean material downhole.

9. The method of claim 1, wherein the treating the subterranean formation occurs about 2.5 hours to about 15 hours after contacting the composition with the subterranean material downhole.

10. The method of claim 1, wherein the treating the subterranean formation comprises degrading at least one of drill-in-fluid (DIF) filter cake deposits and drill-in-fluid (DIF) filter cake residue, located downhole.

11. The method of claim 1, wherein the treating the subterranean formation comprises removing at least one of drill-in-fluid (DIF) filter cake deposits and drill-in-fluid (DIF) filter cake residue, located downhole.

12. The method of claim 1, wherein the treating the subterranean formation comprises increasing downhole flow rate.

13. The method of claim 1, wherein the treating the subterranean formation comprises breaking polymer gels located downhole.

14. The method of claim 1, wherein the treating the subterranean formation comprises breaking polymer gels located downhole, over an extended period of time.

15. The method of claim 1, wherein the treating the subterranean formation comprises delivering acid to the subterranean formation.

16. The method of claim 1, wherein the treating the subterranean formation comprises at least one of an extended release of acid to the subterranean formation and a delayed release of acid to the subterranean formation.

17. The method of claim 1, wherein the treating the subterranean formation comprises at least one of extending a break time in a subterranean formation and delaying a break time in a subterranean formation.

18. The method of claim 1, wherein the treating the subterranean formation is carried out at a temperature up to about 285° F.

19. The method of claim 1, wherein the treating the subterranean formation is carried out at a temperature at least about 220° F.

20. The method of claim 1, wherein the treating the subterranean formation is carried out at a pressure of up to about 200,000 psi.

20. The method of claim 1, which reduces premature fluid loss into a formation.

21. The method of claim 1, wherein the subterranean formation is located in a deep water environment.

22. The method of claim 1, wherein the filter cake breaker comprises an acid generator, configured for the release of acid.

23. The method of claim 1, wherein the filter cake breaker comprises at least one of an alkyl lactate filter cake breaker and an alkyl formate ester filter cake breaker.

24. The method of claim 1, wherein the filter cake breaker is present in at least about 5 wt. % of the composition.

25. The method of claim 1, wherein the filter cake breaker is present in about 5 wt. % to about 25 wt. % of the composition.

26. The method of claim 1, wherein the viscosifier comprises a hydroxyethylcullose (HEC) polymer.

27. The method of claim 1, wherein the viscosifier comprises a hydroxyethylcullose (HEC) polymer dispersed in a water-soluble carrier.

28. The method of claim 1, wherein the viscosifier comprises solvent dispersed hydroxy ethyl cellulose viscosifier.

29. The method of claim 1, wherein the viscosifier comprises a derivatized hydroxyethylcullose (HEC) polymer that is crosslinkable.

30. The method of claim 1, wherein the viscosifier comprises derivatized hydroxylethyl cellulose (HEC) gelling agent.

31. The method of claim 1, wherein the viscosifier is present in about 0.4% to about 2.25 wt. % of the composition.

32. The method of claim 1, wherein the composition further comprises water.

33. The method of claim 1, wherein the composition further comprises brine.

34. The method of claim 1, wherein the composition further comprises at least one of NaCl, KCl, KBr, NaBr, CaCl₂, CaBr₂, ZnBr₂, and ZnCl₂.

35. The method of claim 1, wherein the composition further comprises at least one of:
KCl+KBr,
NaCl+NaBr,
KCl+NaCl,
NaCl+CaCl₂,
CaCl₂+CaBr₂, and
CaCl₂+ZnCl₂.

36. The method of claim 1, wherein the composition further comprises a base.

37. The method of claim 1, wherein the pH buffering agent comprises a near neutral pH buffering agent.

38. The method of claim 1, wherein pH buffering agent comprises alkali bicarbonate breaker pH buffering agent.

39. The method of claim 1, wherein the composition has a pH of about 5-8.

40. The method of claim 1, wherein the composition has a viscosity of up to about 100 cP.

41. The method of claim 1, wherein the composition is gelled.

42. The method of claim 1, wherein the composition is gelled, such that the gelled composition is formed above ground.

43. The method of claim 1, wherein the composition is gelled, such that the gelled composition is formed downhole.

44. A method for delivering acid to a subterranean formation, the method comprising:
obtaining or providing a composition comprising: filter cake breaker, viscosifier, corrosion inhibitor, and pH buffering agent; and
contacting the composition with a subterranean material downhole.

45. The method of claim 44, wherein the acid is released at least about 2.5 hours after the composition is contacted with the subterranean material downhole.

46. The method of claim 44, wherein the acid is released up to about 4 days after the composition is contacted with the subterranean material downhole.

47. The method of claim 44, wherein the acid is released up to about 15 hours after the composition is contacted with the subterranean material downhole.

48. The method of claim 44, wherein the acid is released about 2.5 hours to about 15 hours after the composition is contacted with the subterranean material downhole.

49. A method for extending or delaying a break time in a subterranean formation, the method comprising:
obtaining or providing a composition comprising: filter cake breaker, viscosifier, corrosion inhibitor, and pH buffering agent; and
contacting the composition with a subterranean material downhole.

50. A composition for the treatment of a subterranean formation comprising:
filter cake breaker,
viscosifier,
corrosion inhibitor,
pH buffering agent, and
at least one of drilling fluid, stimulation fluid, fracturing fluid, spotting fluid, clean-up fluid, production fluid, completion fluid, remedial treatment fluid, abandonment fluid, pill, acidizing fluid, cementing fluid, and packer fluid.
